(19) United States
(12) Patent Application Publication
(10) Pub. No.: US 2004/0217934 A1
(43) Pub. Date: Nov. 4, 2004

(54) Driving circuit of flat panel display device

(76) Inventor: Jin-Seok Yang, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,013

(22) Filed: Dec. 23, 2003

(30) Foreign Application Priority Data
Apr. 30, 2003 (KR) 2003-27682
Nov. 20, 2003 (KR) 2003-82601

(51) Int. Cl. G09G 3/36

(52) U.S. Cl. 345/100

(57) ABSTRACT

A driving circuit for driving a flat panel display device by mirroring a reference current at a plurality of channels, includes a reference current block including a current source and a first current mirroring unit configured with MOS transistors of a low voltage device, wherein the first current mirroring unit makes a first mirrored current to be provided to an input of the first current mirroring unit by mirroring the reference current generated from the current source; and a plurality of channels configured with MOS transistors of a high voltage device, wherein each channel includes: a second current mirroring unit outputting a second mirrored current as an output signal by mirroring the first mirrored current; and a switching unit for providing the first mirrored current from the second current mirroring unit to the first current mirroring unit.

### FIELD OF THE INVENTION

The present invention relates to a flat panel display device; and, more particularly, to a driving circuit of the flat panel display device capable of reducing current deviation between each channel by disposing low power devices to a reference current block.

### DESCRIPTION OF RELATED ART

Generally, a flat panel display (FPD) device is classified with an inorganic FPD device and an organic FPD device according to a material used therein. The inorganic FPD device includes a plasma display panel device using photo luminescence (PL) from a fluorescent substance, a filed emission display (FED) device using cathode luminescence or the like, and the organic FPD includes a liquid crystal display (LCD) device universally used in various fields, an organic light emitting device or the like.

A response time of the organic light emitting device is over 30,000 times faster than that of the LCD device, also, since the Recently, since the OLED emits light itself, there are merits having a wide visible angle and a high luminance, so that they are becoming more and more popular as a next generation display device.

FIG. 1 is a block diagram illustrating a typical flat panel display device using the organic light emitting device.

As shown, the flat panel display device using the OLED includes a display panel 10a having a plurality of unit pixels 10d in a matrix type, a segment line controlling unit 10b controlling segment lines and a common line controlling unit 10c for controlling common lines.

The display panel 10a includes a plurality of segment lines in a vertical direction, a plurality of common lines in a horizontal direction, and the unit pixel disposed at each cross point of the segment lines and the common lines. The segment line and the common line are called as a source line and a scan line.

FIG. 2 is a detailed circuit diagram illustrating the organic light emitting device of the flat panel display device in FIG. 1.

As shown, the OLED has the unit pixel per each cross point of the segment lines and the common lines. The unit pixel consists of one light emitting device and one capacitor. The light emitting device and the capacitor are coupled to the segment line and the common line, and they are coupled in parallel each other. In order to light the organic light emitting device, a constant voltage is applied to the common line and a current is provided through the segment line, so that a light is emitted from the organic light emitting device.

FIG. 3 is a circuit diagram illustrating a segment line controlling unit for providing the current to the segment lines illustrated in FIG. 2.

As shown, the segment controlling unit 10b includes a reference current block 11 generating a reference current Iref, a plurality of channels 12 and 13, which are disposed at both sides of the reference current block 11 providing a current to each segment line. One channel provides a current one segment line described in FIG. 2.

The reference current block 11 includes a PMOS transistor Mref11, whose source receives a power supply voltage VDDH of a high voltage and gate are coupled to its drain, for a source, a current source ref1 coupled between a drain of the PMOS transistor Mref11 and a ground voltage.

Each channel includes a PMOS transistor whose source receives a constant power supply voltage VDDH and gate is coupled to the gate of the PMOS transistor Mref11. The PMOS transistor Mn11 for a current copy transistor provides a mirrored current Im to an output terminal OUT. A current ration of Im/Iref has a constant value. When the number of the channels is n, n numbers of PMOS transistors are required to provide mirrored current to each segment line.

As mentioned above, the segment line controlling unit of the typical organic light emitting device has a plurality of MOS transistors disposed to each channel for providing the mirrored current to each segment line.

However, since the organic light emitting device has a plurality of output channels of over hundreds numbers, the segment line controlling unit 10b is disposed to one side in a long type, so that there is a problem that it is difficult to reduce a current offset because a property difference between the PMOS transistor Mref11 for the reference current and the PMOS transistor Mn11 for the mirrored current caused by process variation.

Since a high current is instantly required to drive the organic light emitting device, the MOS transistors Mref11 and Mn11 are used a high voltage device to provide a high current. The high voltage device is a MOS transistor capable of instantly providing a high current by receiving a high voltage different from a normal MOS transistor. The MOS transistor of the high voltage device is made by controlling a width and a length thereof.

FIG. 4 is a circuit diagram illustrating a conventionally improved segment controlling unit to solve the above problem.

As shown, the segment line controlling unit includes a reference current block 21 generating a reference current ref and a plurality of channels 22 and 23 disposed at both sides of the reference current block 21.

The reference current block 21 includes a PMOS transistor, whose source receives a power supply voltage VDDH of a high voltage and gate is coupled to its drain, for a source, a current source ref21 coupled between a drain of the PMOS transistor Mref11 and a ground voltage, and a PMOS transistor Mn21 whose source receives the power supply voltage VDDH and gate is coupled to the gate of the PMOS transistor Mref21 to thereby provide a mirrored current to its drain, for a mirrored current. At this time, a current ratio of Im/Iref is maintained in a constant value.

The channel 23 includes a PMOS transistor Mn22 to acts as a switch for selectively the mirrored current Im generated from the reference current block 21 in response to a signal inputted to it gate, and a level shifter 14 for level-shifting an on/off signal and transmitting the level-shifted on/off signal to the gate of the PMOS transistor Mn22.

As mentioned above, an improved convention segment line controlling unit generates a mirrored current Im at the reference current block 21 by mirroring the current Iref of the current source and the mirrored current Im is provided to each segment line.

According to the improved segment line controlling unit, the high voltage transistors Mref21 and Mn 21 are disposed in the reference current block 21 and the switching transistor Mn22 driven in response to the level-shifted on/off signal is only disposed in each channel, so that the offset current between the reference current block 21 and each channel may be reduced. However, an addition device such a level shifter is still required. Also, as the number of the channels is increased, there is a problem that an area of the reference current block, in which the high voltage transistors are disposed, is increased.

### SUMMARY OF THE INVENTION

It is, therefore, an object of the present invention to provide a driving circuit of a flat panel display device capable of reducing total area of driving circuit and current offset.

In accordance with an aspect of the present invention, there is provided a driving circuit for driving a flat panel display device by mirroring a reference current at a plurality of channels, comprising: a reference current block including a current source and a first current mirroring unit configured with MOS transistors of a low voltage device, wherein the first current mirroring unit makes a first mirrored current to be provided to an input of the first current mirroring unit by mirroring the reference current generated from the current source; and a plurality of channels configured with MOS transistors of a high voltage device, wherein each channel includes: a second current mirroring unit outputting a second mirrored current as an output signal by mirroring the first mirrored current; and a switching unit for providing the first mirrored current from the second current mirroring unit to the first current mirroring unit.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram illustrating a typical flat panel display device using the organic light emitting device;

FIG. 2 is a detailed circuit diagram illustrating the organic light emitting device (OLED) of the flat panel display device in FIG. 1;

FIG. 3 is a circuit diagram illustrating a segment line controlling unit for providing the current to the segment lines illustrated in FIG. 2;

FIG. 4 is a circuit diagram illustrating a conventionally improved segment controlling unit; and

FIG. 5 is a circuit diagram illustrating a segment line controlling unit of an organic light emitting device in accordance with the present invention.

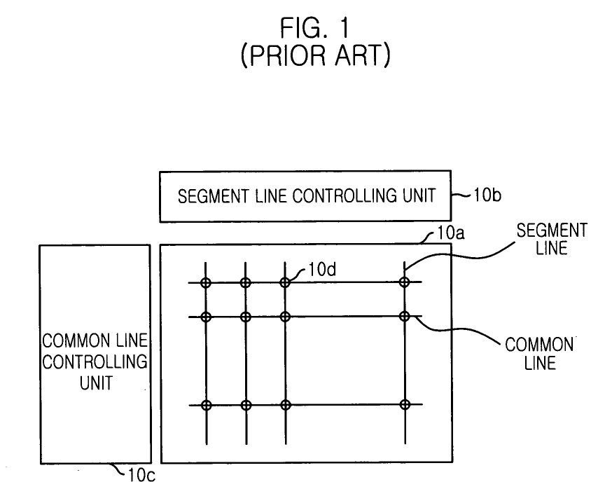

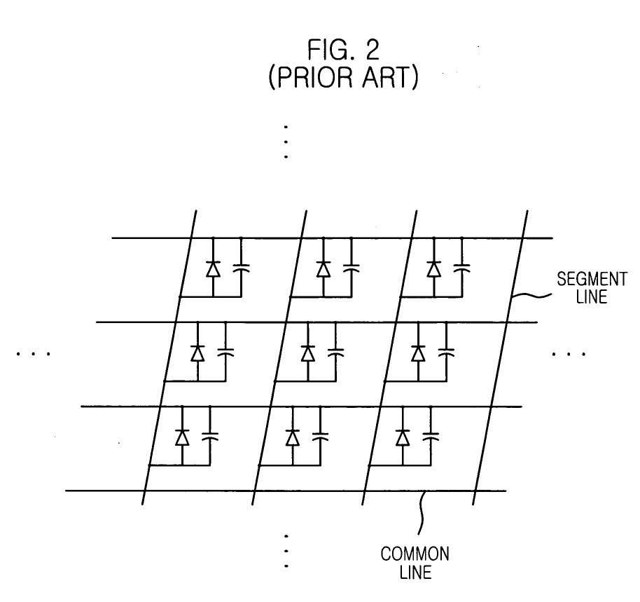

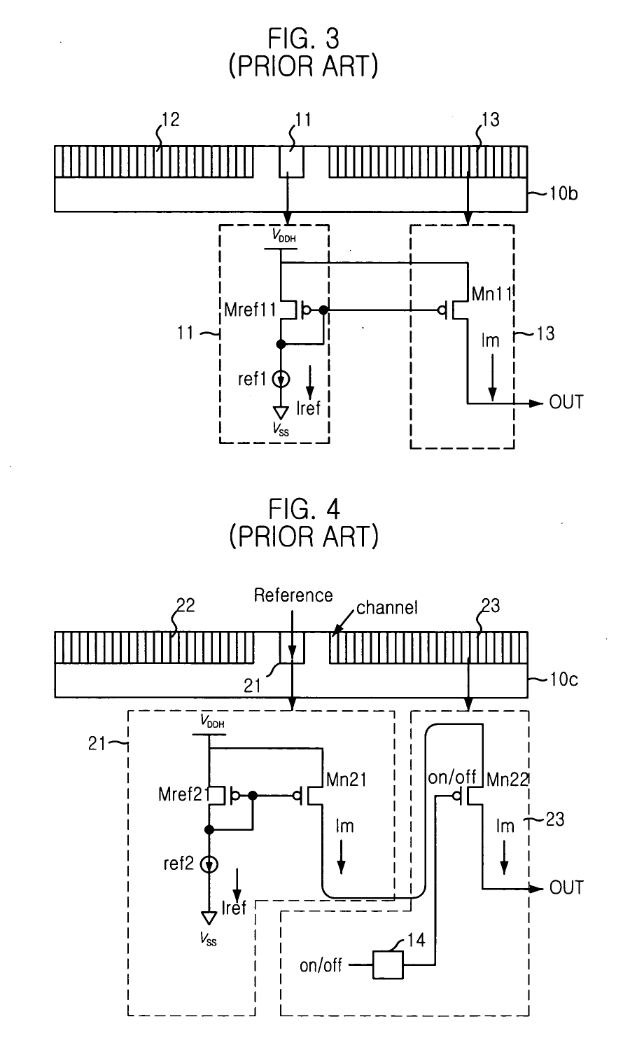

### DETAILED DESCRIPTION OF THE INVENTION

Hereinafter, a driver circuit for a flat panel display device according to the present invention will be described in detail referring to the accompanying drawings.

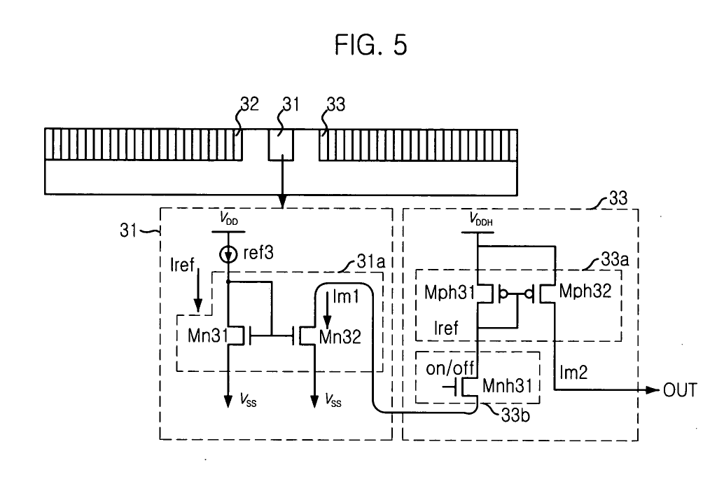

FIG. 5 is a circuit diagram illustrating a segment line controlling unit of an organic light emitting device in accordance with the present invention. Hereinafter, the segment line controlling unit will be referred to as a driving unit because the segment line controlling unit is basically used to drive the flat panel display device.

As shown, the driving unit includes a reference current block 31 and a plurality of channels 32 and 33 disposed at both sides of the reference current block 31. The reference current block 31 generates a mirrored current Im1 by mirroring a reference current Iref to each channel. The reference current block 31 includes a current source ref3 and low voltage MOS transistors Mn31 and Mn32. The low voltage MOS transistors Mn31 and Mn32 configure a first current mirroring unit 31a generating a first mirroring current Im1 by mirroring the reference current Iref3 generated from the current source ref3. Each channel 33 includes a second current mirroring unit 33a, which is configured with high voltage MOS transistors Mph31 and Mph32, outputting a second mirrored current Im2 by mirroring the first mirrored current Im1, and a switching unit for providing the first mirrored current Im1 to an input of the first current mirroring unit 31a. One channel 33 provides a current to one segment lines.

The first current mirroring unit 31a is configured with the first NMOS transistor Mn31 whose gate and drain are coupled to the current source ref3 engaged with a power supply voltage VDD of a low voltage, and the second NMOS transistor Mn32 whose gate is coupled to the gate of the first NMOS transistor Mn31, source is coupled to a ground voltage Vss, and drain receives the first mirrored current Im1 as an input of the first current mirroring unit 31a.

The second current mirroring unit 33a is configured with the first PMOS transistor Mph31 of a low voltage device, whose source is coupled to a high power supply voltage VDDH providing a higher voltage than the power supply voltage VDD, gate and drain are coupled each other, and a second PMOS transistor Mph32 of a low voltage device, whose source is coupled to the high power supply voltage VDDH and gate is coupled to the gate of the first PMOS transistor Mph32 to thereby generate the second mirrored current Im2 through a gate thereof.

The switching unit 33b includes a MOS transistor Mnh31 whose gate receives an on/off control signal on/off, drain is coupled to the gates of the first and second PMOS transistors Mph31 and Mph32, and source is coupled to the input of the first current mirroring unit 31a. The MOS transistor in the switching unit 33b is configured with a high voltage device.

The high voltage device means that the transistor has a tolerance for relatively higher voltage and the low voltage device means that the transistor has a tolerance for relatively lower voltage when fabricating the MOS transistor. For example, if the low voltage device is a MOS transistor fabricated to be used in a voltage ranging from 2.5 V to 3.3 V, the high voltage device is a MOS transistor fabricated to be used in a voltage over 18 V. The high voltage device is fabricated by controlling channel length and width of the MOS transistor.

Since a high current is constantly required in order to drive the organic light emitting device of the flat panel display device using the organic light emitting device, the high voltage device is used in the driving unit.

Hereinafter, an operation of the driving unit of the flat panel display unit in accordance with the preferred embodiment of the invention will be described by referring to FIG. 5.

The reference current. Iref is generated from the current source in the reference current block 31 of the driving unit of the flat panel display device. If the reference current flows from the low power supply voltage VDD to a ground voltage Vss, the first and second NMOS transistors Mn31 and Mn32 are turned on, so that the first mirrored current Im1 mirroring the reference current Iref flows through the second NMOS transistor Mn32.

Subsequently, if the on/off control signal on/off is applied to the gate of the MOS transistor Mnh31 of the switching unit 33b, the first mirrored current Im1 flows from the high power supply voltage VDDH to the ground voltage Vss through the MOS transistors Mph31, Mnh31 and Mn32. If the first mirrored current Im1 flows through the first PMOS transistor Mph31, the second PMOS transistor Mph32 is turned on to thereby output the second mirrored current Im2 as an output signal. The second mirrored current Im2 is provided to each segment line of the flat panel display device.

As mentioned above, the driving unit of the flat panel display device includes the second current mirroring unit 33a configured with the high voltage transistor Mph31 and Mph32 and the reference current block 31 configured with the low voltage transistors Mn31 and Mn32 providing the reference current Iref for driving the second current mirroring unit 31a. Therefore, the reference current block generating the reference current provided to the plurality of channels of the flat panel display device is configured only with a low voltage device in accordance with the present invention.

Accordingly, since the reference current block is configured only with the low voltage device, i.e., a size of the low voltage device is relatively smaller than that of the high voltage device, there is an effect that a burden increasing the area of the reference current block is reduced.

Also, since the low voltage device is less varied than the high voltage device for the process variation, current variation of the low voltage device is less that that of the high voltage device, so that there is an effect that an offset of the second mirrored current Im2 is reduced.

While the present invention has been described with respect to the particular embodiments, it will be apparent to those skilled in the art that various changes and modifications may be made without departing from the spirit and scope of the invention as defined in the following claims.

What is claimed is:

1. A driving circuit for driving a flat panel display device by mirroring a reference current at a plurality of channels, comprising:
a reference current block including a current source and a first current mirroring unit configured with MOS transistors of a low voltage device, wherein the first current mirroring unit makes a first mirrored current to be provided to an input of the first current mirroring unit by mirroring the reference current generated from the current source; and
a plurality of channels configured with MOS transistors of a high voltage device, wherein each channel includes:
a second current mirroring unit outputting a second mirrored current as an output signal by mirroring the first mirrored current; and
a switching unit for providing the first mirrored current from the second current mirroring unit to the first current mirroring unit.

2. The driving circuit as recited in claim 1, wherein the first current mirroring unit includes:
a first NMOS transistor of a low voltage device, whose gate and drain are coupled to the current source engaged with a low power supply voltage, and source is coupled to a ground voltage; and
a second NMOS transistor of the low voltage device, whose gate is coupled to the gate of the first NMOS transistor, source is coupled to the ground voltage, and drain receives the first mirrored current provided from the second current mirroring unit as an input signal.

3. The driving circuit as recited in claim 2, wherein the second current mirroring unit includes:
a first PMOS transistor of a high voltage device, whose source is coupled to a high power supply voltage and gate is coupled to its drain; and
a second PMOS transistor of a high voltage device, whose source is coupled to the high power supply voltage and gate is coupled to the gate of the first PMOS transistor to thereby generate an output signal to its drain.

4. The driving circuit as recited in claim 3, wherein the switching unit includes a MOS transistor, whose gate receives an on/off control signal, drain is coupled to the drains of first and second PMOS transistor, and source is coupled to the input of the first current mirroring unit.

5. The driving circuit as recited in claim 4, wherein the MOS transistor is a high voltage device.

6. The driving circuit as recited in claim 1, wherein one channel controls one driving line of the flat panel display device.
